(19) United States
(12) Patent Application Publication
(10) Pub. No.: US 2011/0232174 A1
(43) Pub. Date: Sep. 29, 2011

(54) GARDEN IN A PACKAGE

(75) Inventor: Lance Mills, Oklahoma City, OK (US)

(73) Assignee: MM&LMPROPERTIES, LLC, South Padre Island, TX (US)

(21) Appl. No.: 12/730,788

(22) Filed: Mar. 24, 2010

(51) Int. Cl. A01G 9/02; A01G 9/24; A01G 13/02; A01G 25/16

(52) U.S. Cl. 47/20.1; 47/66.1; 47/79; 47/66.6; 47/66.7

(57) ABSTRACT

A raised bed garden assembly, kit, and method are provided. The garden assembly comprises a prefabricated enclosure along with additional components useful for creating a raised bed garden or similar growing enclosure, such as an irrigation system and greenhouse covering. The garden assembly can be provided in a kit for easily establishing a garden and growing fruits and vegetables at home, along with soil and plants. The garden enclosure can be a monolithic, self-sustaining body that is unitarily formed, or it can be modular. The modular enclosure comprises sidewalls and corner members, which are unitarily formed modular pieces that can be detachably-connected to define the enclosure shape. Advantageously, the enclosure is devoid of any non-integral attachment elements.

### BACKGROUND OF THE INVENTION

1. Field of the Invention

The present invention relates to a garden assembly, method, and kit containing the components necessary to establish a raised bed garden.

2. Description of Related Art

Raised bed gardens have been used for many years to grow plants where cultivation of the native soil is problematic or too time-consuming. Raised bed gardens have the advantage of improved soil conditions, higher yields, ease of access, and better pest control. After the initial construction process, raised bed gardens generally require less maintenance than a traditional garden bed. Typically, raised bed gardens are constructed using wood or similar materials to contain the soil and plants. However, wood raised bed gardens are subject to rot, pest infestation, expansion and contraction, and weakening of joints. In addition, the time and expense involved in constructing a raised bed garden deters many people from growing their own fruits and vegetables at home. Moreover, traditional raised bed gardens are not suitable for small spaces, such as balconies or decks. There remains a need for easier methods of establishing a garden and growing fruits and vegetables at home.

### SUMMARY OF THE INVENTION

The present invention is broadly concerned with a garden assembly comprising an enclosure for containing soil and plants. The enclosure is cooperatively formed by a plurality of sidewalls and corner members. The enclosure is a laterally closed body and defines an interior space open at the bottom (as well as at the top). Advantageously, the enclosure is devoid of non-integral attachment elements, a feature that facilitates assembly and use of the enclosure and avoids problems associated with detachable attachment hardware, such as brackets, bolts, or screws.

A raised bed garden kit is also provided. The kit comprises a garden assembly, along with soil, and plants. The garden assembly comprises an enclosure for containing soil and plants cooperatively formed by a plurality of sidewalls and corner members. The enclosure is a laterally closed body that defines an interior space open at the bottom (as well as at the top). Advantageously, the enclosure is devoid of non-integral attachment elements.

The present invention is also broadly concerned with a method of forming a raised bed garden. The method comprises providing an enclosure for containing soil and plants. The enclosure is a laterally closed body cooperatively formed by a plurality of sidewalls and corner members, which defines an interior space open at the bottom (as well as at the top). The sidewalls and corner members are cooperatively formed by respective interior walls and exterior walls joined by substantially parallel top and bottom surfaces, wherein the interior walls define the perimeter of the interior space of the enclosure. The enclosure sidewalls comprise a plurality of projections integrally formed with the bottom surfaces and extending inward from the interior walls. The enclosure is placed on the ground, with the bottom surfaces in contact with the ground. A mesh grid is placed in the interior space, adjacent the sidewall projections, and soil is added to the interior space (on top of the mesh grid). Advantageously, the enclosure is devoid of non-integral attachment elements.

A further method of forming a raised bed garden is also provided in the invention. The method comprises providing a garden assembly comprising an enclosure for containing soil and plants and a mesh grid. The enclosure is a laterally closed body cooperatively formed by a plurality of sidewalk and corner members, and defining an interior space open at the bottom (as well as at the top). The sidewalls and corner members are cooperatively formed by respective interior walls and exterior walls joined by substantially parallel top and bottom surfaces, wherein the interior walls of the sidewalls and corner members define the perimeter of the interior space. The enclosure sidewalls also comprise a plurality of projections integrally formed with the bottom surfaces and extending inward from the interior walls, wherein the mesh grid is adjacent these projections. The enclosure is placed on the ground with the bottom surfaces in contact with the ground, and soil is added to the interior space of the enclosure (on top of the mesh grid). Advantageously, the enclosure is devoid of non-integral attachment elements.

### BRIEF DESCRIPTION OF THE DRAWINGS

FIG. 1 is an environmental view of a raised bed garden created using a garden assembly kit in accordance with the invention;

FIG. 2 is an isometric view of a modular enclosure in accordance with the invention;

FIG. 3 illustrates the female and male connection mechanism for connecting the modular sidewalls and corner members of a modular enclosure in accordance with the invention;

FIG. 4 is a partial cross-section of a depressible tab and catch engaged by an opening in the mating connection element of a modular enclosure in accordance with the invention;

FIG. 5 is an underside (bottom) isometric view of an enclosure with a mesh grid in accordance with the invention;

FIG. 6 illustrates a mesh grid and enclosure of a garden assembly in accordance with the invention;

FIG. 7 is a detailed, fragmentary isometric view with portions of the enclosure sidewall removed showing an irrigation system in accordance with the invention;

FIG. 8 depicts a garden assembly comprising an enclosure and arched support members for supporting a covering in accordance with the invention; and

FIG. 9 depicts a garden assembly comprising an enclosure and a covering in accordance with the invention.

### DETAILED DESCRIPTION OF THE INVENTION

The following sets forth the invention with reference to the preferred embodiments illustrated in the Figures. It is to be understood, however, that these preferred embodiments are provided by way of example and nothing therein should be taken as a limitation upon the overall scope of the invention that is claimed.

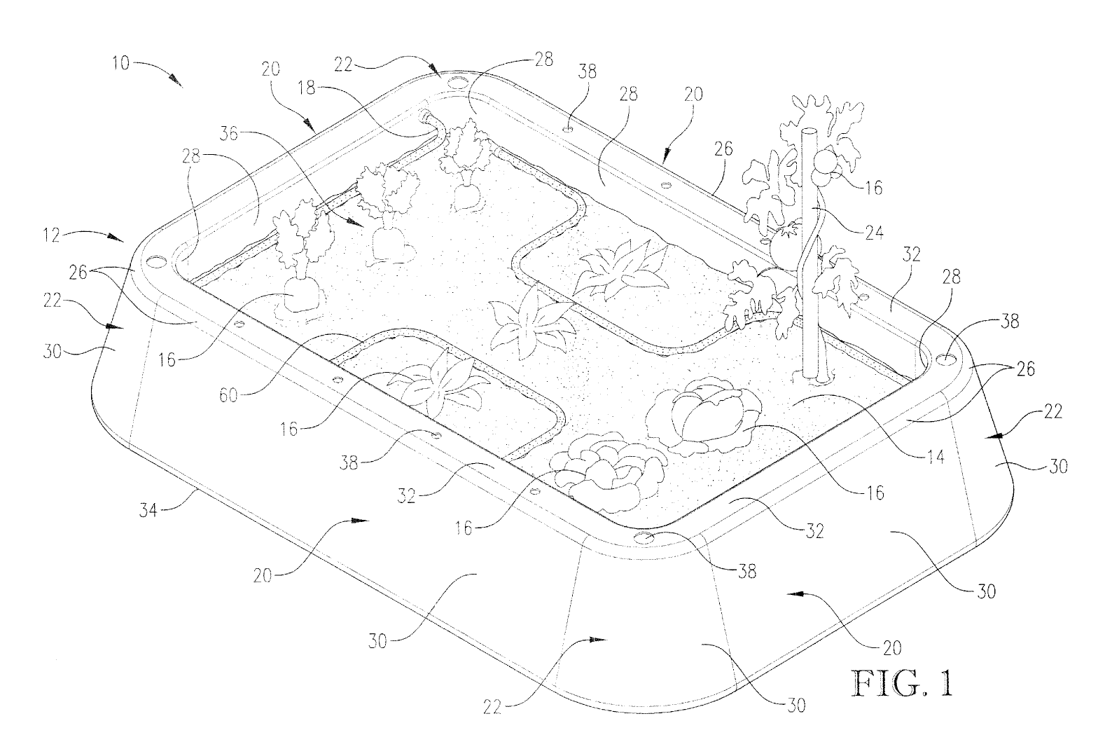

Referring to FIG. 1, a garden assembly 10 in accordance with the invention is provided. The garden assembly 10 includes a prefabricated enclosure 12, and can be provided in a kit including the components useful for creating a raised bed garden or similar growing container, such as sod 14 and plants 16. The garden assembly 10 can also include an irrigation system 18, including a hose or sprinkler for supplying water to the plants. Advantageously, the garden assembly 10 provides a convenient and efficient way for at-home gardeners to establish a garden and grow fruits and vegetables at home. The garden assembly 10 comprises an enclosure 12 cooperatively formed by a plurality of sidewalls 20 and corner members 22, which contains the soil 14 and plants 16, along with the irrigation system 18 of the garden. Stakes 24 can also be included in the kit for supporting the plants 16.

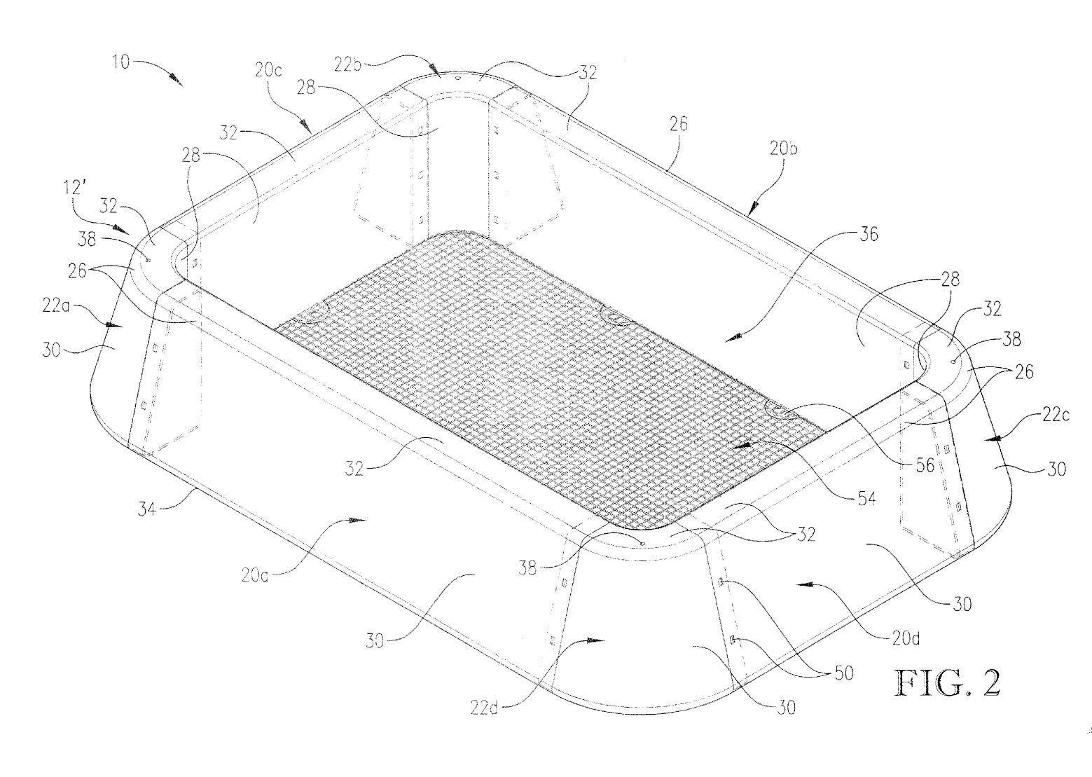

In one aspect, the enclosure 12 is a monolithic, self-sustaining body (i.e., the enclosure 12 is unitarily formed, such as by extrusion molding or blow molding of plastic). The term “unitarily formed” as used herein is interchangeable with the term “integrally formed” and means that such unitarily formed parts are “integral” and are not attached to each other in a separate step or detachable from each other, but are formed from a single piece of material. In another aspect of the invention, the enclosure 12′ is modular wherein the sidewalls 20 and corner members 22 of the enclosure 12′ are modular pieces that can be detachably connected to define the enclosure 12′. For example, as depicted in FIG. 2, a pair of sidewalls 20a, 20b are joined together at substantially right angles to another pair of sidewalls 20c, 20d via four curved corner members 22a-22d, forming a laterally enclosed, substantially rectangular shape. In the modular embodiment, the individual pieces are each self-sustaining bodies that are preferably unitarily formed from a single piece of material, such as by extrusion molding or blow molding of plastic. Thus, whether monolithic or modular, the enclosure preferably consists only of sidewalls and corner members.

The sidewalk 20 of the enclosure 12, 12′ are generally straight along their lateral (horizontal) length, whereas the corner members 22 are generally arcuate along their length to define corners of the enclosure 12, 12′. The sidewalls 20 and corner members 22 of the enclosure 12, 12′ are each cooperatively formed by respective interior walls 28 and exterior walls 30, joined by substantially parallel top surfaces 32 and bottom surfaces 34. The top and bottom surfaces 32, 34 can be joined to the interior walls 28 and exterior walls 30 by curved edge surfaces 26, as depicted in the figures. The enclosure 12, 12′ is preferably a laterally closed body, such as a rectangle or square, presenting an interior space 36, with the interior walls 28 defining the perimeter of the interior space 36 of the enclosure 12, 12′. The modular enclosure 12′ has the advantage of ease of transportation and handling of individual dismantled pieces, when compared to the monolithic enclosure 12. In addition, the shape and size of the modular enclosure 12′ can be easily changed by the at-home gardener by simply adding additional sidewalls 20.

The sidewalls 20 and corner members 22 can be hollow or solid, and can be made of any suitable material, such as those selected from the group consisting of high density polyethylene (HDPE), polyethylene terephthalate (PET), polyermized lactic acid (PLA), and combinations thereof. The overall length of the enclosure 12, 12′ preferably ranges from about 60 inches to about 84 inches. The overall width of the enclosure 12, 12′ preferably ranges from about 36 inches to about 72 inches. The “overall” length or width as used herein means the largest measurement end-to-end for a given dimension. The interior space 36 of the enclosure 12, 12′, preferably has a length of from 48 inches to about 72 inches, and a width of from about 30 inches to about 48 inches. It will be appreciated that the size and shape of the enclosure 12, 12′ can be modified without departing from the scope of the invention. When the enclosure is hollow, the thickness of each of the interior and exterior walls 28, 30 and top and bottom surfaces 32, 34 is preferably from about ¼ inches to about 1/16 inches, respectively. The enclosure 12, 12′ preferably has an overall height (as defined by the height of the tallest interior 28 or exterior 30 wall) of at least about 16 inches, more preferably from about 16 inches to about 30 inches.

Preferably, the width of the top surfaces 32 ranges from about 3 inches to about 6 inches, more preferably from about 4 inches to about 5 inches, and even more preferably from about 4.5 inches to about 5 inches. The width of the bottom surfaces 34 preferably ranges from about 8 inches to about 12 inches, more preferably from about 9 inches to about 11 inches, and even more preferably from about 9.5 inches to about 10 inches. The top surfaces 32 of the sidewalls 20 and corner members 22 preferably include a plurality of apertures 38 for attachment or insertion of additional components of the garden assembly 10 or accessories for use with the assembly. For example, the top surface 32 of the corner member 22 oldie enclosure 12, 12′ can include an aperture for attaching a seat. The apertures 38 preferably have a diameter of from about ½ inches to about 3 inches, more preferably from about ½ inches to about 2 inches, and even more preferably from about ½ inches to about 1 inch. The apertures 38 are depicted in the drawings as circles, although it will be appreciated that these openings can be provided in any number of shapes.

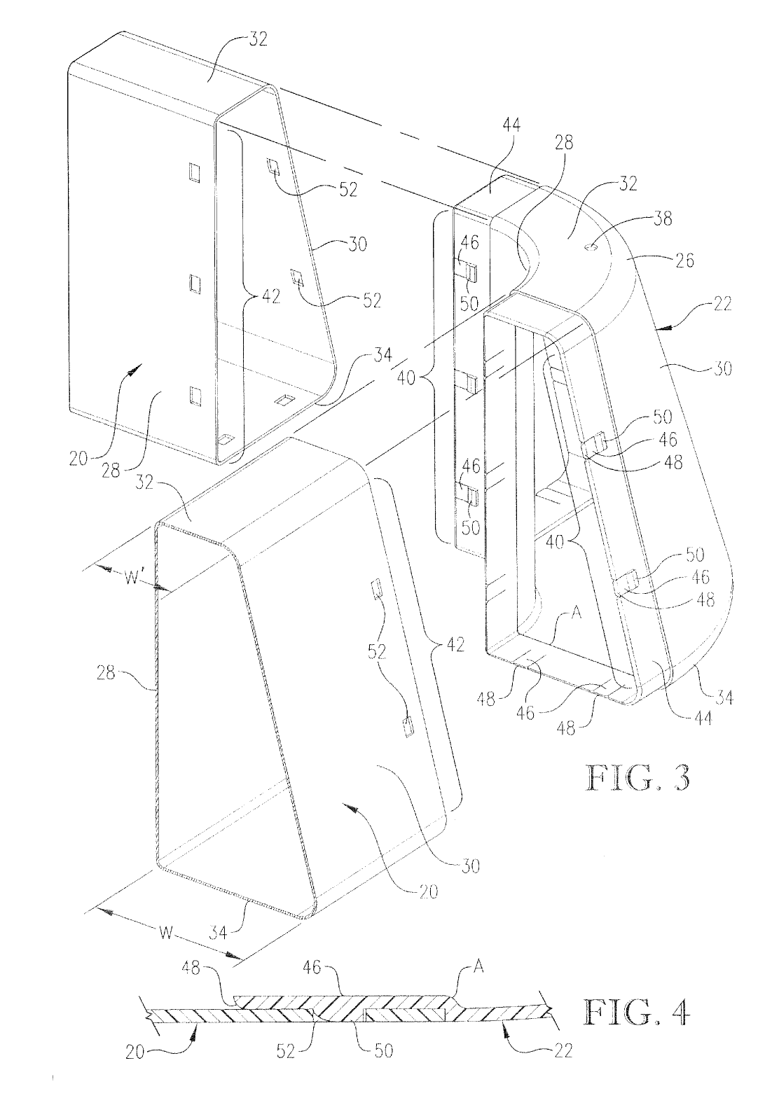

The interior and exterior walls 28, 30 can be substantially parallel, in which case the interior and exterior walls 28, 30 are substantially the same height, as measured from the top surface 32 to the bottom surface 34. Alternatively, as depicted in the figures, the exterior walls 30 can be sloped away from the interior walls 28, such each exterior wall 30 has a vertical “length”, as measured from the top surface 32 to the bottom surface 34, which is greater than the height of the corresponding interior wall 28, as measured from the top surface 32 to the bottom surface 34. In this embodiment, the width W of the bottom surface 34 is larger than the width W′ of the top surface 32, as shown, for example, in FIG. 3. More specifically, the width W of the bottom surface 34 is preferably from about 1.75 to about 2.5 times the width W′ of the top surface 32, and more preferably from about 1.75 to about 2 times the width W′ of the top surface 32.

With reference to FIGS. 3-4, the sidewalls 20 and corner members 22 of the modular enclosure 12′ comprise integral male connection (or attachment) elements 40 or female connection elements 42 at their respective ends for detachably connecting the sidewalls 20 to the corner members 22. In FIG. 3, the corner member 22 comprises a male connection element 40 at each end. The male connection element 40 comprises a flange 44 and resilient, depressible tabs 46 for engaging the mating connection element 42 of the corresponding sidewall 20. More specifically, the flange 44 is configured to be received in the female connection element 42 of the corresponding sidewall 20. The depressible tabs 46 are preferably integrally molded or formed with the corner member 22 (or sidewall 20, depending upon the location of the male connection element), and terminate in a free edge 48. Preferably, the free edges 48 of the tabs 46 do not extend beyond the edge of the flange 44, as shown in FIG. 3. This minimizes the chance of the tab 46 breaking off. The tabs 46 each comprise a catch 50 projecting outwardly from the tab 46 and spaced from the free edge 48. The female connection elements 42 are characterized by openings 52 defined in and disposed along the interior and exterior walls 28, 30 and bottom surfaces 34. These openings 52 are configured to receive the catch 50 of the depressible tabs 46. The depressible tabs 46 “hinge” or bend at about point A (FIG. 4) when the catch 50 is depressed. That is, when the male connection element 40 is received in the female connection element 42, the depressible tab 46 is compressed inwardly, and then flexes back into position when the catch 50 is received in the corresponding opening 52 of the female connection element 42 to lock the tab 46 (and accordingly the two pieces) in place. This is depicted in FIG. 4. To release the connection and disassemble the garden assembly, the catch 50 is pressed, depressing the tab 46 and the male and female connection elements 40, 42, are pulled apart. Advantageously, because the connection elements 40, 42 are unitarily formed with the enclosure 12′, there are no tools required for assembly or disassembly of the enclosure 12′, and no additional fasteners to lose or break. That is, whether monolithic or modular, the enclosure is preferably free of or devoid of non-integral (i.e., discrete, separate, detachable) attachment elements, such as screws, snaps, brackets, bolts, staples, nails, etc., or any combination thereof. It will be appreciated that the male and female connection elements 40, 42, can be configured such that the sidewalls 20 comprise the male connection elements 40, while the corner members 22 comprise the female connection elements 42. Alternatively, each piece can be provided with a female connection element 42 at one end and a male connection element 40 at the other end, such that any one piece may be connected to any other piece (e.g., two sidewalls may be connected in series, etc.).

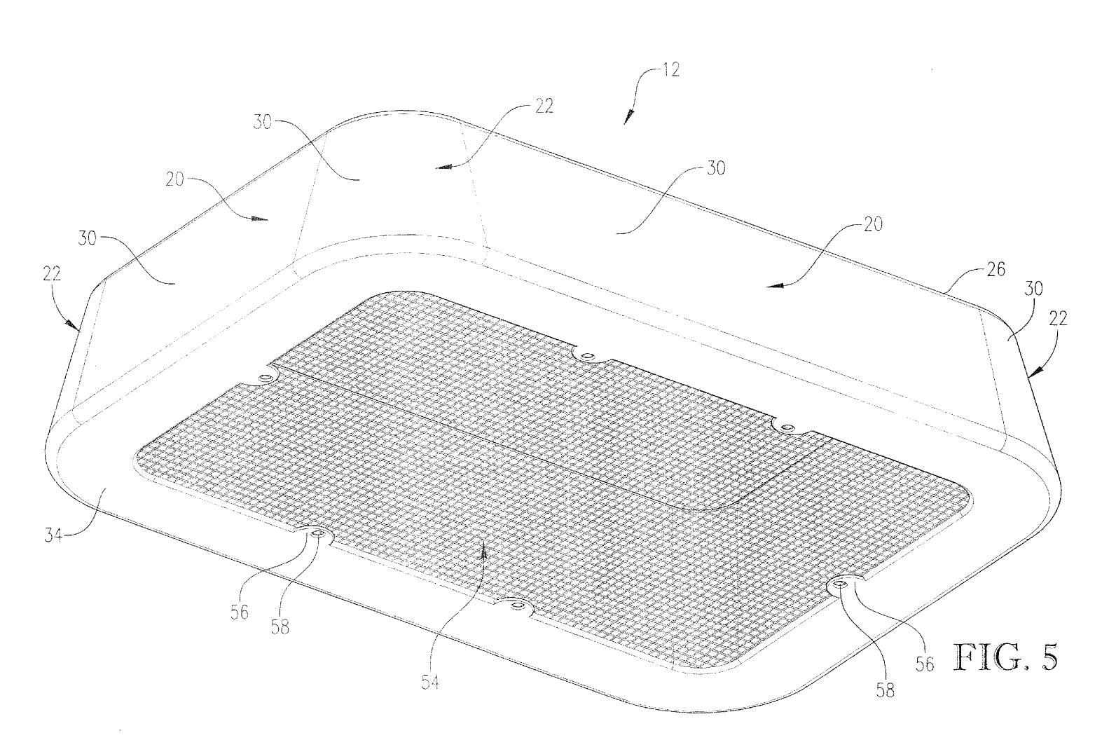

In addition to being open at the top, the interior space 36 of the enclosure 12, 12′ is also preferably open at the bottom, and the garden assembly preferably comprises a mesh grid bottom 54, shown in FIGS. 2 and 5, which is held in place by projections 56 that are integrally formed with the bottom surface 34 of the enclosure 12, 12′, and project inwardly from the interior walls 28 of the enclosure 12, 12′. Depending on its size, the enclosure 12, 12′ preferably comprises from about 6 to about 12 projections, more preferably from about 6 to about 10 projections, and even more preferably from about 8 to about 10 projections around the perimeter of the interior space. It is particularly preferred that each sidewall 20 of the enclosure 12, 12′ comprises at least one projection 56 to prevent the mesh grid 54 from falling through the bottom of the enclosure 12, 12′. The projections 56 are preferably provided with holes 58 for securing the mesh grid 54 to the enclosure 12, 12′ and/or for securing the enclosure 12, 12′ to the ground using stakes inserted through the mesh grid 54 and/or projection hole 58 into the ground (not shown). Advantageously, the mesh grid 54 permits water to drain from the interior space 36 of the enclosure 12, 12′, while preventing the intrusion of pests such as gophers from beneath the garden.

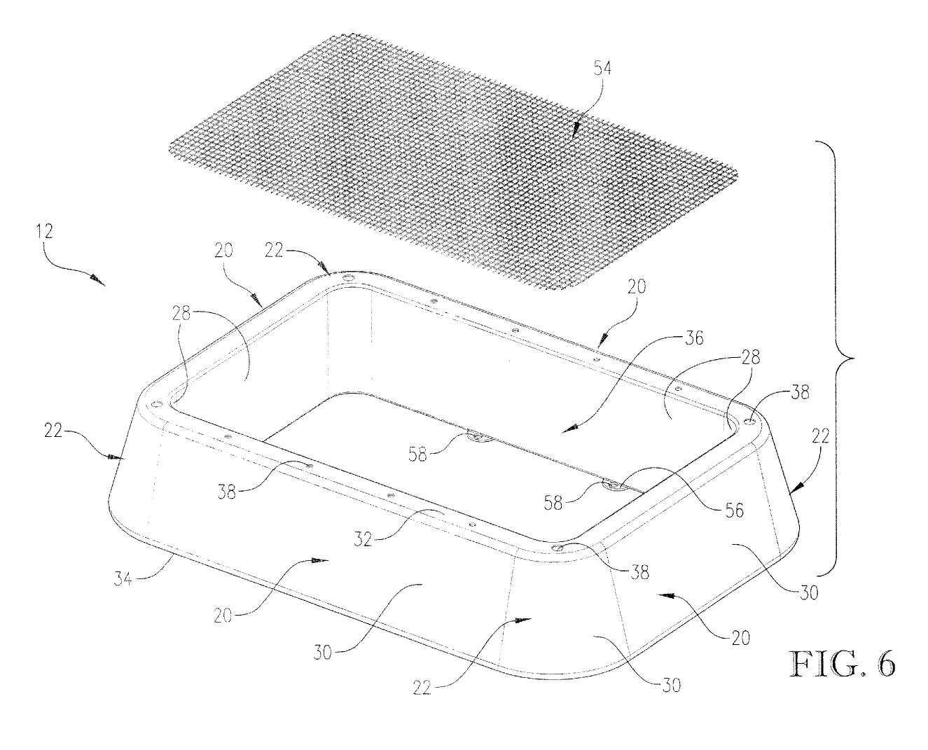

As illustrated in FIG. 6, the mesh grid 54 is preferably configured to be inserted into the interior space 36 of the enclosure. Preferably, the perimeter of the mesh grid 54 contacts the perimeter (interior walls 28) of the interior space 36 of the enclosure 12, 12′, and in any case, at least overlaps with the projections 56 to prevent the mesh grid 54 from falling through the open bottom of the enclosure 12, 12′. In addition to, or in lieu of the stakes, the mesh grid 54 will be held in place against the projections 56 by the weight of the garden soil once added to the enclosure 12, 12′. Suitable materials for the mesh grid 54 are selected from the group consisting of hard plastic, polymer, and galvanized metal (e.g., welded wire, poultry wire, vinyl coated wire mesh fencing). The mesh grid preferably has an overall width of less than about 72 inches and a length of less than about 84 inches, more preferably the grid has a width of about 36 inches to about 72 and a length of from about 72 inches to about 84 inches. The mesh itself preferably has a mesh size with a width of about ¼ inches or less and a length of about 2 inches or less (i.e., about ¼ inches×2 inches), more preferably the mesh size ranges from about ¼ inches×¼ inches to about 2 inches×2 inches, with ¼-inch square mesh grid being particularly preferred.

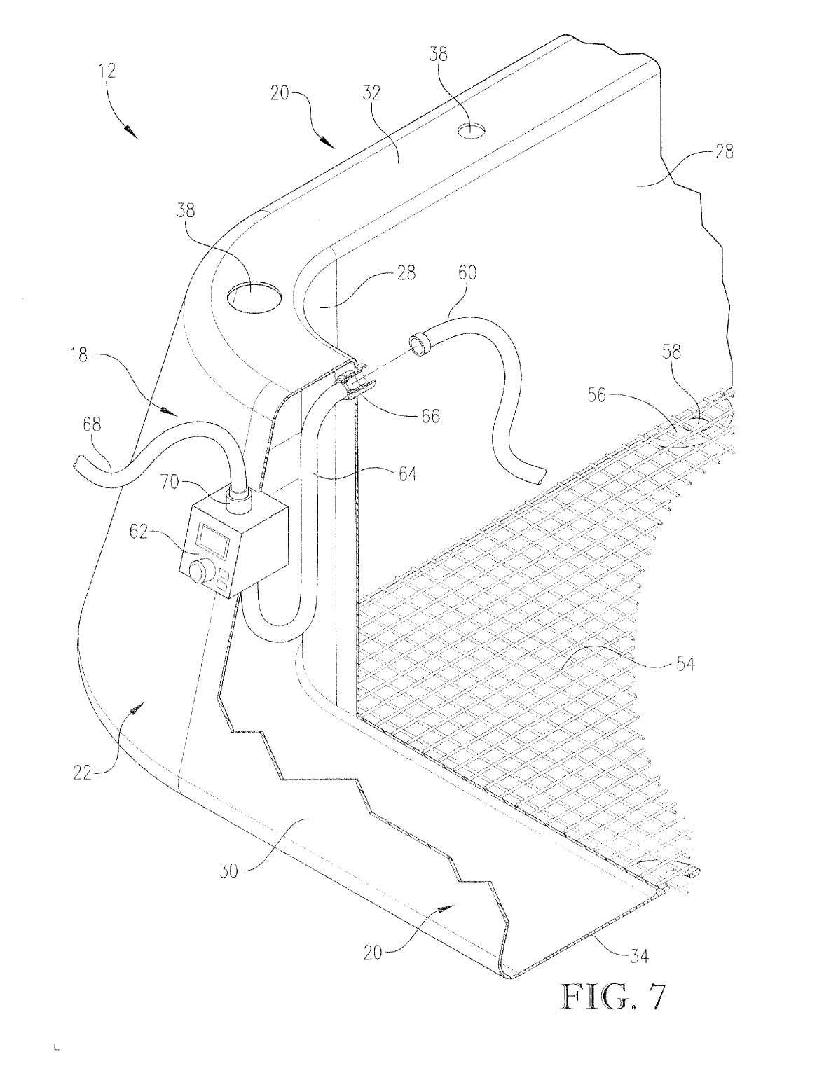

As shown in FIG. 7, the garden assembly 10 can be provided with an irrigation system 18 to supply water to the plants to facilitate their growth. Water can be supplied to the plants in the garden by way of a soaker hose, sprinkler, drip irrigation emitters, sprays, jets, bubblers, or any other suitable watering apparatus 60. The irrigation system 18 can include a timer 62 for automatically controlling the supply of water to the plants. The timer 62 is connected to the watering apparatus 60 via a hose or pipe 64, extending from the exterior wall 30 of the enclosure 12, 12′ to the interior wail 28 of the enclosure 12, 12′ where a coupling 66 (e.g., hose end pipefitting, permanent coupling, etc.) is provided for attaching the watering apparatus 60. The timer 62 is also attached to a water supply source, such as an outdoor water spigot or rainwater catchment barrel, via a hose or pipe 68 attached to a second coupling 70 on the timer 62 on the exterior wall 30 of the enclosure 12, 12′. The irrigation system 18 includes a valve (not shown) that is controlled by the timer 62. Suitable timers are known in the art.

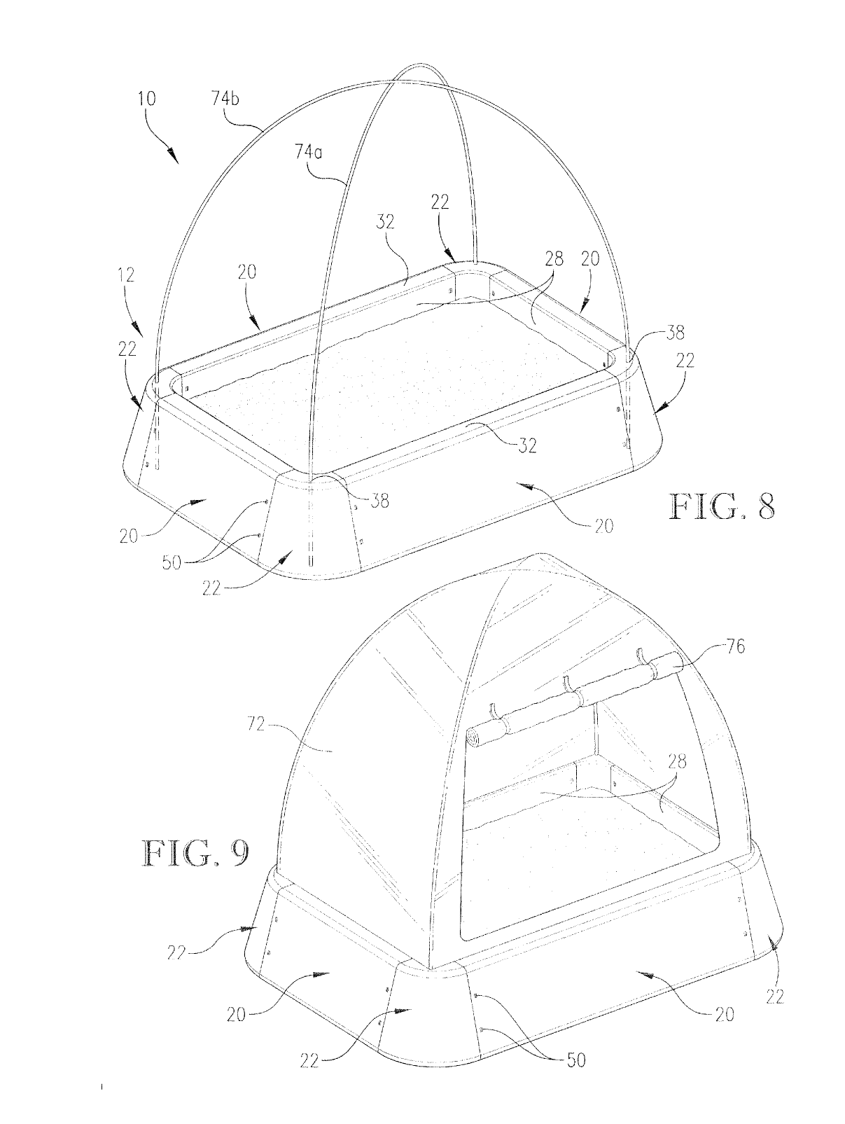

The garden assembly 10 can also comprise a covering 72 as shown in FIGS. 8-9 disposed over arched support members 74a, 74b. Flexible poles having respective ends configured to be inserted at each end into the apertures 38 in the top surface 32 of each corner member 22 are crisscrossed to thereby form the flexible, resilient, arched support members 74a, 74b for the covering, similar to a tent. The poles can be made of aluminum, fiberglass, plastic, or metal alloy/graphite. The covering 72 is stretched over and attached to the arched supports 74a, 74b by any number of suitable attachment methods. For example, a plurality of fabric-like or plastic-like straps can be positioned across the top covering 72 in line with the arched support poles 74a, 74b and made to encircle the poles using hook and loop fasteners (VELCRO®) or by tying, thereby connecting the covering to the arched support members 74a, 74b. The covering 72 can be any suitable material depending upon the desired purpose for the covering (i.e., protect seedlings from the elements, act as a greenhouse, act as a cold frame to protect the bed during winter, shade, etc.). In one embodiment, the covering 72 serves as a greenhouse and comprises a substantially clear material, preferably plastic. The covering 72 preferably has an access flap 76 that can be rolled up and secured to gain access to the plants in the garden. As shown in FIG. 9, the flap 76 can simply be tied up, but it will be appreciated that any number of fasteners may be used to secure the flap 76.

The arched support members 74a, 74b can also be used to support a lighting system for facilitating use of the garden assembly indoors (not shown). The lighting system preferably comprises fluorescent light bulbs, and more preferably daylight spectrum fluorescent light bulbs. It will be appreciated that for indoor use, a saucer, tray, or other suitable apparatus may be utilized underneath the enclosure to collect water, which drains from the open bottom of the interior space 36 during watering of the garden. Alternatively, the garden assembly may be situated near a drain, such as a floor drain in a basement, for water drainage.

The enclosure 12, 12′ can also comprise an electrical system. More specifically, the enclosure 12, 12′ can be configured with internal wiring, an outlet (not shown) on an exterior wail 30 of the enclosure 12, 12′, and a corresponding extension cord, so that the enclosure can be plugged into a power source, thereby providing power to the enclosure 12, 12′. The enclosure 12, 12′ can then, in turn, supply power to various components utilized with the garden assembly. As such, the irrigation system timer 62 and/or lighting system can be plugged into the outlet on the enclosure 12, 12′, minimizing the number of cords extending between the enclosure 12, 12′ and the power source.

Referring back to FIG. 1, as noted above, the garden assembly 10 can be provided in a kit along with soil 14 and plants 16. The term “soil” as used herein refers to any suitable combination of planting media, such as dirt, rock, humus, sand, peat moss, zeolite, organic matter, and the like. Fertilizer and/or compost can also be included in the soil 14 or as a separate component in the kit. The term “plants” 16 as used herein includes seeds and seedlings, as well as flowering or vegetative plants. The garden assembly 10 is suitable for growing any type of plant (vegetables, flowers, fruits, etc.).

In use, the enclosure 12, 12′ is placed on the ground with the bottom surface 34 in contact with the ground. In embodiments where the enclosure 12′ is provided in modular form, the enclosure 12′ is first assembled by connecting the sidewalls 20 and corner members 22, as described above. Preferably, the enclosure 12, 12′ is not elevated on legs, castors, or the like. The enclosure 12, 12′ is particularly suited to outdoor use on the ground, but can be used indoors or out on a solid surface, such as a patio or deck, with suitable drainage. When used on an impervious surface, a gasket or seal (not shown) can be added to the bottom surfaces 34 of the sidewalls 20 and corner members 22, which contacts the ground and thereby prevents migration of soil from the interior space 36 out from underneath the enclosure 12, 12′. The mesh grid 54 is placed inside the interior space 36 of the enclosure 12, 12′. The enclosure 12, 12′ and/or mesh grid 54 can then be secured in place to the ground using stakes as previously described. Soil 14 (including fertilizer and/or compost, as applicable) can be added to the interior space 36 of the enclosure 12, 12′. The seeds, seedlings, or plants 16 can then be buried in the soil 14, like a traditional garden. Stakes 24 can be placed in the soil 14 next to the plants 16 for support, as shown in FIG. 1. Stakes 24 can also be inserted into the apertures 38 in the top surface 32 of the sidewalls 20 to support the plants 16 located around the periphery of the interior space 36 of the enclosure 12, 12′. These stakes 24 could also be used to support fencing (not shown) around the enclosure 12, 12′ to prevent rabbits, deer, and other pests from gaining access to the plants 16 in the garden. The garden bed can also be mulched to reduce evaporation. The irrigation system 18 can be installed by connecting the watering apparatus 60 to the coupling 66 on the interior wall 28 of the enclosure 12, 12′, and likewise, connecting a hose or pipe 68 connected to a water supply source to the second coupling 70 on the timer 62. The watering apparatus 60 can be placed on top of the soil 14 in the interior space 36 of the enclosure 12, 12′, or buried beneath the soil or mulch In the case of a soaker hose, the watering apparatus 60 can be made to weave in and out of the plants, as shown in FIG. 1, to supply water as close as possible to the individual plants. The irrigation system 18 may also be installed before adding any seeds, plants, or seedlings 16.

It will be appreciated that a number of accessories may be provided with the kit or utilized with the garden assembly. For example, a weed barrier or weed block fabric (that still allows drainage) can be added on top of the mesh grid 54 of the enclosure 12, 12′ before adding the soil 14 to prevent weeds from growing in the garden. A seat can be provided with a post for inserting into one of the apertures 38 on the top surface 32 of the enclosure 12, 12′ to provide a resting place for when working in the garden. A compost barrel can also be included in the kit. As mentioned above, the water source for the irrigation system 18 can be from a rainwater catchment barrel. Thus, the kit can also comprise a rainwater catchment system comprising a barrel for collecting rainwater channeled from the roof, gutters, and downspouts of a structure, with a spigot for releasing the water from the barrel. Interior divider panels can also be provided to separate plants. Other accessories include signs, bird houses, bird feeders, trellis, stakes, stools, and cages (tomato cages, etc.). Finally, it will be appreciated that the kit can also comprise a variety of tools utilized for gardening (e.g., hand trowel, hand spade, garden cultivators, hand weeder, bulb planter, rake), along with a gardening manual and instructions for assembling and using the garden assembly.

1. A garden assembly comprising:
an enclosure for containing soil and plants, said enclosure being a laterally closed body cooperatively formed by a plurality of sidewalls and corner members and defining an interior space open at the bottom, wherein said enclosure is devoid of non-integral attachment elements.

2. The garden assembly of claim 1, said sidewalls and corner members being cooperatively formed by respective interior walls and exterior walls joined by substantially parallel top and bottom surfaces, wherein said interior walls define the perimeter of the interior space of said enclosure.

3. The garden assembly of claim 2, said enclosure being a monolithic, unitarily formed, self-sustaining body.

4. The garden assembly of claim 2, said enclosure comprising modular, detachably-connected sidewalls and corner members, each of said sidewalls and corner members being respective, unitarily formed, self-sustaining bodies.

5. The garden assembly of claim 4, said sidewalls and corner members having respective ends, wherein each of said ends comprises an integrally-formed male connection element or female connection element.

6. The garden assembly of claim 5, said female connection element comprising openings defined in said interior and exterior walls and said bottom surface, said male connection element comprising an integrally-formed flange and an integrally-formed, resilient, depressible tab, said tab comprising a catch configured to engage the openings of the female connection element of a corresponding sidewall or corner member.

7. The garden assembly of claim 2, said enclosure further comprising a plurality of projections integrally-formed with said bottom surfaces and extending inward from said interior walls, said garden assembly further comprising a mesh grid adjacent said projections.

8. The garden assembly of claim 1, said enclosure consisting of said sidewalls and corner members.

9. A raised bed garden kit comprising:
a garden assembly, said garden assembly comprising
an enclosure for containing soil and plants said enclosure being a laterally closed body cooperatively formed by a plurality of sidewalls and corner members and defining an interior space open at the bottom, wherein said enclosure is devoid of non-integral attachment elements;
soil; and
plants.

10. The kit of claim 9, said sidewalls and corner members of said enclosure being cooperatively formed by respective interior walls and exterior walls joined by substantially parallel top and bottom surfaces, wherein said interior walls define the perimeter of the interior space of said enclosure.

11. The kit of claim 10, said garden assembly further comprising a mesh grid.

12. The kit of claim 11, said enclosure further comprising a plurality of projections integrally-formed with said bottom surfaces and extending inward from said interior walls, wherein said mesh grid is adjacent said projections.

13. The kit of claim 9, said top surfaces including a plurality of apertures.

14. The kit of claim 13, said garden assembly further comprising flexible poles having respective ends configured to be inserted at each end into said apertures in the top surface of each corner member of said enclosure to thereby form arched supports for said garden assembly.

15. The kit of claim 14, said garden assembly further comprising a covering configured to be disposed over said arched supports.

16. The kit of claim 14, said garden assembly further comprising a lighting system.

17. The kit of claim 13, further comprising a seat comprising a post configured to be received in at least one of said apertures.

18. The kit of claim 9, said garden assembly further comprising an irrigation system.

19. The kit of claim 18, said irrigation system comprising a timer.

20. The kit of claim 9, further comprising an accessory selected from the group consisting of a rainwater catchment system, compost barrel, interior divider panels, gardening manual, instructions, gardening tools, signs, bird houses, bird feeders, trellis, stakes, stools, cages, and combinations thereof.

21. A method of forming a raised bed garden comprising:
providing an enclosure for containing soil and plants, said enclosure being a laterally closed body cooperatively formed by a plurality or sidewalls and corner members and defining an interior space open at the bottom, wherein said sidewalls and corner members are cooperatively formed by respective interior walls and exterior walls joined by substantially parallel top and bottom surfaces, said interior walls defining the perimeter of said interior space, and wherein said enclosure sidewalls comprise a plurality of projections integrally formed with said bottom surfaces and extending inward from said interior walls;
placing said enclosure on the ground, wherein said bottom surfaces are in contact with the ground;
placing a mesh grid in said interior space adjacent said projections; and
adding soil to said interior space, wherein said enclosure is devoid of non-integral attachment elements.

22. The method of claim 21, said enclosure comprising modular sidewalls and corner members, each of said sidewalls and corner members being respective, unitarily formed, self-sustaining bodies.

23. The method of claim 22, wherein said providing comprises assembling said enclosure by detachably connecting said modular sidewalls and corner members to thereby form said laterally closed body.

24. The method of claim 21, further comprising planting plants in said soil.

25. A method of forming a raised bed garden comprising:
providing a garden assembly comprising
an enclosure for containing soil and plants, said enclosure being a laterally closed body cooperatively formed by a plurality of sidewalls and corner members, and defining an interior space open at the bottom, wherein said sidewalls and corner members are cooperatively formed by respective interior walls and exterior walls joined by substantially parallel top and bottom surfaces, said interior walls defining the perimeter of said interior space, and wherein said enclosure sidewalls comprise a plurality of projections integrally formed with said bottom surfaces and extending inward from said interior walls; and
a mesh grid adjacent said projections;
placing said enclosure on the ground, wherein said bottom surfaces are in contact with the ground; and
adding soil to said interior space, wherein said enclosure is devoid of non-integral attachment elements.

26. The method of claim 25, said enclosure being a monolithic, unitarily formed, self-sustaining body.

27. The method of claim 25, further comprising planting plants in said soil.
